(19) United States
(12) Patent Application Publication
(10) Pub. No.: US 2011/0301271 A1
(43) Pub. Date: Dec. 8, 2011

(54) TWO-LIQUID TYPE URETHANE PAINT COMPOSITION

(75) Inventors: Eishi Tsukamoto, Yokohama-shi (JP); Tatsuo Hayakawa, Yokohama-shi (JP); Makoto Iuchi, Yokohama-shi (JP); Yasufumi Honda, Yokohama-shi (JP)

(73) Assignee: BASF Coatings Japan Ltd., Yokohama (JP)

(21) Appl. No.: 13/201,768

(22) PCT Filed: Jan. 19, 2010
(86) PCT No.: PCT/IB2010/000087

§ 371 Date: Aug. 16, 2011

(30) Foreign Application Priority Data
Feb. 16, 2009 (JP) 2009-032896

(51) Int. Cl. C08K 5/05

(52) U.S. Cl. 524/389

(57) ABSTRACT

Disclosed is a two-liquid type urethane paint composition having a main agent which includes a hydroxyl group-containing resin (A), a hydrolyzable ester compound (B) and an alcohol-based solvent (C); and a curing agent which includes a polyisocyanate compound (D). The composition is made by mixing together the main agent and the curing agent, wherein the (B) component and the (C) component are included in the main agent in amounts from 2 to 35 parts by mass as effective component of the hydrolyzable ester compound (B) and from 2 to 10 parts by mass of the alcohol-based solvent (C) per 100 parts by mass of solid fraction of the hydroxyl group-containing resin (A), and the hydroxyl groups of the hydroxyl group-containing resin (A) and the functional groups of the polyisocyanate compound (D) are mixed in proportions of from 0.5 to 1.5 as the mol ratio of NCO/OH.

### TECHNICAL FIELD

The present invention concerns a two-liquid type urethane paint composition of which the use-time (pot-life) is extended and with which good coating operability is obtained by controlling the reaction of the isocyanate groups of the polyisocyanate compound in the curing agent with the hydroxyl groups of the hydroxyl group-containing resin in the main agent.

### TECHNICAL BACKGROUND

Urethane paints are widely used in the coating field and characteristically they are two-liquid type paints comprising a main agent paint which is a hydroxyl group-containing resin composition and a curing agent which has a polyisocyanate compound as the main agent and, after mixing, they become very thick or gel after a fixed period of time and there is an intrinsic problem in that painting and cleaning operations must be completed before this occurs (this period is called the use-time or pot-life), and there is another problem in that the cleaning operation imposes a greater burden than with a one-liquid type paint. It is desirable that the use-time (pot-life) should be extended as far as possible in order to simplify these operations.

Curing agent compositions which contain from 1 to 40 wt % polyisocyanate compound, from 0.1 to 5.0 wt % de-watering agent and from 55 to 98.9 wt % organic solvent are known as curing agent compositions for use with acrylic urethane paints which have excellent storage stability, are easy to use and with which there is little variability in the paint film performance (for example, see Patent Citation 1). In this citation, methyl orthoformate, ethyl orthoformate, methyl orthoacetate, ethyl orthoacetate and the like which are hydrolyzable ester compounds are disclosed as de-watering agents and, furthermore, aromatic hydrocarbons such as toluene, xylene and the like, ketones such as acetone, methyl ethyl ketone and the like, and esters such as ethyl acetate, butyl acetate and the like are disclosed as organic solvents. However, alcohols react with the polyisocyanate compounds and so they are not disclosed as organic solvents.

However, this composition is a curing agent composition and the storage stability of the curing agent composition itself is excellent, but there is a problem in that it has no effect on the use-time (pot-life) after mixing with the main agent paint (hydroxyl group-containing resin composition).

Furthermore, there is a known method of stabilizing paint in which the rise in viscosity of a top-coat paint is suppressed and the suitability for electrostatic painting, the properties of the cured paint film and the staining resistance in particular can be maintained in a process in which a top-coat paint composition in which from 1 to 70 parts by weight of a partially hydrolyzed condensate of an organosilicate compound has been compounded in 100 parts by weight of a thermally curing paint composition having a hydroxyl group-containing acrylic resin as the base resin and an amino resin or an isocyanate compound as a curing agent is coated electrostatically with an inert gas sealing the empty part within the circulation tank of said top-coat paint composition and the humidity in the empty part within the circulation tank set below 5000 g/m³ (for example, see Patent Citation 2). This method is a way of overcoming the problematic rise in paint viscosity caused by the water which is introduced into the paint from the air in those cases where the thermally curable resin composition includes a partially hydrolyzed condensate of an organosilicate compound and silicon crosslinking is involved. Moreover, in this method it is disclosed that aromatic hydrocarbons, alcohols and de-watering agents (for example trimethyl orthoacetate, triethyl orthoacetate, triethyl orthoformate, triethyl orthoformate, hydrolyzable silicon compounds and the like) are introduced with a view to controlling the viscosity of the top-coat paint in the circulation tank through which the aforementioned top-coat paint is being circulated.

However, the aim of this method is, as mentioned above, to prevent a rise in viscosity of the paint due to the deterioration of the partially hydrolyzed condensate of an organosilicate compound caused by water and there is a drawback in that the humidity must be set to no more than 5000 g/m³ with a means other than the components of the composition such as sealing the empty part within the circulation tank with inert gas. Moreover, this method is a way of overcoming the problematic rise in the paint viscosity of a paint where the thermally curing paint composition includes a partially hydrolyzed condensate of an organosilicate compound, and there is no mention at all of paints which do not include a partially hydrolyzed condensate of an organosilicate compound.

As disclosed in the abovementioned citations, hydrolyzable ester compounds are used as de-watering agents and it is known that these react with water and form alcohols, but at the same time it is also known that alcohol-exchange reactions occur in the presence of alcohols. In those cases where the alcohol is a mono-functional alcohol-based solvent, even if it is present along with hydrolyzable ester compounds, the mono-functional alcohol solvent is simply replaced by the alcohol-exchange reaction and there is no change in the apparent state, but in those cases where a poly-functional compound which has hydroxyl groups such as a hydroxyl group-containing resin or the like is also present there is a problem in that the state of the mixture becomes much more viscous as a result of the alcohol-exchange reaction. Consequently hydrolyzable ester compounds are not generally mixed with polyfunctional compounds which have hydroxyl groups such as hydroxyl group-containing resins and the like.

On the other hand, an alcohol-based solvent (C) reacts with isocyanate groups and so adding an alcohol-based solvent as a third component to a hydroxyl group-containing resin and a crosslinking agent (polyisocyanate compound) has the effect of extending the use-time (pot-life). However, the effect is not very great but rather results in a loss of crosslinking ability and there is a problem in that it has an adverse effect on the paint film performance of a urethane paint composition.

### PRIOR ART CITATIONS

### Patent Citations

### Patent Citation 1:

Japanese Unexamined Patent Application Laid Open H5-345871

### Patent Citation 2:

Japanese Unexamined Patent Application Laid Open 2000-303024

### SUMMARY OF THE INVENTION

### Problems to be Resolved by the Invention

The aim of the present invention is to provide a two-liquid type urethane paint composition with which the use-time (pot-life) is extended by controlling the reaction of the two-liquid type urethane paint, and with which good painting operability is obtained as a result.

### Means of Resolving these Problems

As a result of thorough research carried out with a view to resolving these problems the inventors have discovered that if a hydrolyzable ester compound is added as a third component to a two-liquid type urethane paint composition comprising a main agent which includes hydroxyl group-containing resin and a curing agent which includes a polyisocyanate compound then even if the reaction of the isocyanate groups with the hydroxyl groups is suppressed by an alcohol-exchange reaction, the hydrolyzable ester compound itself acts as a crosslinking agent of the hydroxyl group-containing resin and so there is only a slight use-time (pot-life) extending effect but it was discovered that by adding a specific amount of an alcohol-based solvent as a fourth component together with the third component there is a greater use-time (pot-life) extending effect and that it is possible to obtain good painting operability as a result. It has been hypothesized that the mode of action is that the alcohol-exchange reaction which occurs in the co-presence of the hydrolyzable ester compound and the alcohol-based solvent acts to block the reaction of the isocyanate groups in the curing agent with the hydroxyl group-containing resin.

That is to say, the present invention provides a two-liquid type urethane paint composition which is a paint composition comprising: a main agent which includes a hydroxyl group-containing resin (A), a hydrolyzable ester compound (B) and an alcohol-based solvent (C); and a curing agent which includes a polyisocyanate compound (D), the composition being obtained by mixing together the main agent and the curing agent, wherein the (B) component and the (C) component are included in the main agent in such a way that there are from 2 to 35 parts by mass as effective component of the hydrolyzable ester compound (B) and from 2 to 10 parts by mass of the alcohol-based solvent (C) per 100 parts by mass of solid fraction of the hydroxyl group-containing resin (A), and the hydroxyl groups of the hydroxyl group-containing resin (A) and the functional groups of the polyisocyanate compound (D) are mixed in proportions of from 0.5 to 1.5 as the mol ratio of NCO/OH.

Furthermore, the invention provides a two-liquid type urethane paint composition as claimed in claim 1, wherein the hydroxyl group-containing resin (A) is an acrylic resin and the polyisocyanate compound (D) is an aliphatic polyisocyanate compound.

### Effect of the Invention

The two-liquid type urethane paint compositions of this invention enable the use-time of a two-liquid type urethane paint composition when the main agent and the curing agent have been mixed to be extended and enable good painting operability to be obtained.

### EMBODIMENT OF THE INVENTION

Acrylic resins, polyester resins, alkyd resins, epoxy resins, polyether resins, polyurethane resins, fluorinated resins and the like can be used, for example, for the hydroxyl group-containing resin (A) which is used in this invention, and these can be used individually, or a combination of two or more types can be used. From among these the acrylic resins are preferred.

The hydroxyl group value of the hydroxyl group-containing resin (A) is preferably from 50 to 220 mgKOH/g, and most desirably from 80 to 200 mgKOH/g.

In those cases where the hydroxyl group value of the hydroxyl group-containing resin (A) is less than 50 mgKOH/g the crosslinking of the paint film is inadequate and so the paint film performance in terms of hardness, resistance to chemical attack and the like tends to decline, and in those cases where it exceeds 220 mgKOH/g the compatibility with the curing agent is inadequate and so a decline in the external appearance of the paint film tends to arise.

Furthermore, the number average molecular weight of the hydroxyl group-containing resin (A) is preferably from 1,000 to 30,000, and most desirably from 2,000 to 20,000.

In those cases where the number average molecular weight of the hydroxyl group-containing resin (A) is less than 1,000 the curing properties of the paint and the durability of the cured paint film tend to decline, and in those cases where it exceeds 30,000 the operability during painting and the external appearance of the cured paint film tend to decline.

A case where the hydroxyl group-containing resin which is used in this invention is a hydroxyl group-containing acrylic resin is described below.

A hydroxyl group-containing acrylic resin can be obtained by polymerizing a radically polymerizable monomer which has a hydroxyl group.

Examples of radically polymerizable monomers which have a hydroxyl group include (meth)acrylic acid hydroxyalkyl esters such as 2-hydroxyethyl(meth)acrylate, 3-hydroxypropyl(meth)acrylate, 4-hydroxybutyl(meth)acrylate and the like, unsaturated aliphatic alcohols such as allyl alcohol and the like, and ethylene oxide and/or propylene oxide adducts of 2-hydroxyethyl acrylate, 2-hydroxypropyl acrylate, 3-hydroxypropyl acrylate, 4-hydroxybutyl acrylate, 2-hydroxyethyl methacrylate, 2-hydroxypropyl methacrylate, 3-hydroxypropyl methacrylate or 4-hydroxybutyl acrylate, and one of these or a mixture of two or more types can be used.

Units originating from other radically polymerizable monomers may be included in the hydroxyl group-containing acrylic resin.

Hydroxyl group-containing acrylic resins which include units originating from other radically polymerizable monomers can be obtained by copolymerizing other radically polymerizable monomers with radically polymerizable monomers which have a hydroxyl group.

Actual examples of other radically polymerizable monomers include acrylic acid esters such as methyl acrylate, ethyl acrylate, n-propyl acrylate, isopropyl acrylate, n-butyl acrylate, isobutyl acrylate, sec-butyl acrylate, hexyl acrylate, cyclohexyl acrylate, 2-ethylhexyl acrylate, octyl acrylate, lauryl acrylate, stearyl acrylate and the like, methacrylic acid esters such as methyl methacrylate, ethyl methacrylate, n-propyl methacrylate, isopropyl methacrylate, n-butyl methacrylate, isobutyl methacrylate, sec-butyl methacrylate, hexyl methacrylate, cyclohexyl methacrylate, 2-ethylhexyl methacrylate, octyl methacrylate, lauryl methacrylate, stearyl methacrylate and the like, acrylic acid, methacrylic acid, styrene, acrylonitrile, methacrylonitrile, acrylamide, methacrylamide and the like, and one of these or a mixture of two or more types can be used.

A radical polymerization initiator may be compounded in those cases where radical polymerization is carried out. Examples of radical polymerization initiators include azo compounds such as 2,2′-azobisisobutyronitrile, 2,2′-azobis-2,4-dimethylvalero-nitrile, 4,4′-azobis-4-cyanovaleric acid, 1-azobis-1-cyclohexanecarbonitrile, dimethyl-2,2′-azobisiso-butyrate and the like, and organic peroxides such as methyl ethyl ketone peroxide, cyclohexanone peroxide, 3,5,5-trimethylhexanone peroxide, 1,1-bis(t-butyl-peroxy)-3,3,5-trimethylcyclohexane, 1,1-bis(t-butyl-peroxy)-cyclohexane, 2,2-bis(t-butylperoxy)octane, t-butyl hydroperoxide, diisopropylbenzene hydro-peroxide, dicumyl peroxide, t-butylcumyl peroxide, isobutyl peroxide, lauroyl peroxide, benzoyl peroxide, diisopropyl peroxydicarbonate, t-butylperoxy 2-ethyl-hexanoate, t-butylperoxy neodecanate, t-butylperoxy laurate, t-butylperoxy benzoate, t-butylperoxyisopropyl carbonate and the like. One radical polymerization initiator may be used individually, or a combination of two or more types may be used.

No particular limitation is imposed upon the amount of radical polymerization initiator compounded but an amount of from 0.01 to 20 mass % with respect to the total amount of radically polymerizable monomer is preferred.

Reducing agents such as dimethylaniline, a ferrous salt such as ferrous sulfate, ferrous chloride, ferrous acetate or the like, acidic sodium sulfite, sodium thiosulfate, rongalite and the like may be combined in these radical polymerization systems, but they must be selected with care so that the polymerization temperature does not become too low.

Examples of the hydrolyzable ester compounds (B) which are used in the invention include methyl orthoformate, ethyl orthoformate, n-propyl orthoformate, methyl orthoacetate, ethyl orthoacetate, ethyl orthopropionate, methyl orthobutyrate and the like. Ethyl orthoacetate and ethyl orthopropionate are especially desirable hydrolyzable ester compounds.

The two-liquid type paint compositions of this invention are compositions where a main agent and a curing agent are mixed immediately before use and then used, and the amount of hydrolyzable ester compound (B) compounded is specified with respect to the solid fraction of the hydroxyl group-containing resin (A) in the main agent. That is to say, the amount of the hydrolyzable ester compound (B) included in the main agent is selected in such a way that there are from 2 to 35 parts by mass, and preferably from 4 to 20 parts by mass, as the effective component, of the hydrolyzable ester compound (B) per 100 parts by mass of solid fraction of the hydroxyl group-containing resin (A). With less than 2 parts by mass of the (B) component the effect of extending the use-time is lacking, and if the amount exceeds 35 parts by mass then the cost is high (problems with the economics) and the solvent balance in the paint composition is lost and the external appearance of the paint film declines.

Mono-functional alcohols with carbon numbers C1 to C10, and preferably with carbon numbers C2 to C8, are preferred for the alcohol-based solvent (C) which is used in the invention. Alcohols such as methanol, ethanol, n-propanol, isopropanol, n-butanol, isobutanol, amyl alcohol, cyclohexanol, benzyl alcohol and the like can be cited as actual examples.

The two-liquid type urethane paint compositions of this invention are compositions where a main agent and a curing agent are mixed immediately before use and then used, and the amount of alcohol-based solvent (C) is specified with respect to the solid fraction of the hydroxyl group-containing resin (A) in the main agent. That is to say, the amount of alcohol-based solvent (C) included is selected so that there are from 2 to 10 parts by mass, and preferably from 4 to 8 parts by mass, per 100 parts by mass of solid fraction of the hydroxyl group-containing resin (A). With less than 2 parts by mass of the (C) component the effect of extending the use-time is lacking and if the amount exceeds 10 parts by mass then the crosslinking ability of the two-liquid type urethane paint composition is lost, which has an adverse effect on the paint film performance.

The polyisocyanate compound (D) which is used in a two-liquid type paint composition of this invention is a polyisocyanate compound which has in one molecule at least two, and preferably three or more, isocyanate functional groups which react with hydroxyl groups, and one of these compounds may be used individually or a mixture of two or more types may be used.

As polyisocyanate compounds which have two or more isocyanate groups in one molecule, aromatic diisocyanates such as 4,4-diphenylmethane diisocyanate, tolylene diisocyanate and xylylene diisocyanate, or aliphatic polyisocyanates such as 1,4-tetramethylene diisocyanate, hexamethylene diisocyanate and 2,2,4-trimethylhexane-1,6-diisocyanate, or biuret forms, isocyanurate forms or adducts with poly-functional alcohols of alicyclic polyisocyanates such as isophorone diisocyanate and methylcyclohexyl diisocyanate, for example, can be used as curing agents.

From among these the use of the aliphatic polyisocyanate compounds is preferred from the viewpoints of weather resistance and yellowing in particular.

The amount of curing agent (D) of this invention included is an amount whereby the proportion of the number of functional groups to the hydroxyl groups of the hydroxyl group-containing resin (A) as the mol ratio NCO/OH is from 0.5 to 1.5, and preferably from 0.8 to 1.2. In those cases where the mol ratio of isocyanate groups with respect to hydroxyl groups is less than 0.5 an adequate crosslink density cannot be obtained and so the performance of the paint film in respect of hardness, resistance to chemical attack and the like declines, and in those cases where it exceeds 1.5 unreacted polyisocyanate compound remains and the paint film performance, in respect of hardness and weather resistance, and the external appearance of the paint film decline.

The two-liquid type urethane paint compositions of this invention may also include one or more type of pigment, dye, glitter agent and the like, and they can be used as they are or with the addition, as required, of one or more other organic solvents (excluding alcohol-based solvents) and various additives such as, for example, ultraviolet absorbers, light-stabilizers, antioxidants, surfactants, surface adjusting agents, curing reaction catalysts, anti-static agents, perfumes and rheology controlling agents such as polyethylene wax, polyamide wax, internally crosslinked type resin particles and the like. Moreover, these added components are preferably included in the main agent. However, the two-liquid type urethane paint compositions of this invention do not contain a partially hydrolyzed condensate of an organosilicate compound.

The two-liquid type paint compositions of this invention may be used as clear paints, or colorants such as dyes, pigments and the like can be compounded and they can be used as colored paints, but they are preferably used as top-coat paint compositions.

The two-liquid type paint compositions of this invention can be painted on a variety of base materials. Examples of the abovementioned base materials include natural or synthetic materials including metals such as iron, aluminum, copper and alloys thereof, inorganic materials such as glass, cement, concrete and the like, various resins such as polyethylene resin, polypropylene resin, ethylene/vinyl acetate copolymer resin, polyamide resin, acrylic resin, vinylidene chloride resin, polycarbonate resin, polyurethane resin, epoxy resin and the like and plastics such as the various types of FRP, timber and fibrous materials (paper, cloth and the like). Furthermore, paint films may have been formed on these base materials with other paints.

The two-liquid type urethane paint compositions of this invention can be applied using a variety of painting methods and, for example, a paint film can be obtained by applying a composition so as to provide a dry paint film thickness of from 10 to 80 μm and then drying at a temperature of from normal temperature to about 160° C.

### ILLUSTRATIVE EXAMPLES

The invention is described in more practical terms below by means of examples and comparative examples, but the invention is not limited by these examples.

### Examples of Production

### Production of Hydroxyl Group-Containing Resin Solution A-1

Xylene (33.9 parts) was introduced into a four-necked flask which was furnished with a thermometer, a reflux condenser, a stirrer and a dropping funnel and heated to and maintained at 140° C. with stirring under a nitrogen atmosphere. Then a drip-feed component obtained by uniformly mixing 5 parts of t-butylperoxy-2-ethylhexanoate as polymerization initiator with radically polymerizable monomer comprising 18.4 parts butyl methacrylate, 9 parts styrene, 5.7 parts 2-ethylhexyl methacrylate, 18.9 parts 4-hydroxybutyl acrylate, 7.5 parts 2-hydroxyethyl methacrylate and 0.5 part acrylic acid was added dropwise from the dropping funnel at a uniform rate at a temperature of 140° C. over a period of 2 hours. After the drip feed had been completed the temperature of 140° C. was maintained for 1 hour and then the reaction temperature was lowered to 110° C. Subsequently a polymerization initiator solution where 0.1 part of t-butylperoxy-2-ethylhexanoate as polymerization initiator had been dissolved in 1 part of xylene was added as supplementary catalyst and the reaction was completed by maintaining a temperature of 110° C. for 2 hours and the hydroxyl group-containing resin solution A-1 was obtained. The resin hydroxyl group value of the resin solution (A-1) obtained was 176.7 mgKOH/g, the involatile fraction was 63.7 mass %, and the number average molecular weight measured using gel permeation chromatography (GPC) was 3,800.

### Examples 1 to 6

The components of the main agents disclosed in Table 1 were mixed sequentially and each mixture was stirred until uniform to prepare a main agent in advance, and then a curing agent was mixed with the main agent so prepared and the mixtures were stirred until they became uniform and the clear paint compositions of Examples 1 to 6 were obtained. The results obtained on evaluation are shown in Table 1. Moreover, the paint film performance was evaluated with the procedure indicated hereinafter after preparing test pieces.

### Comparative Examples 1 to 8

The components of the main agents disclosed in Table 2 were mixed sequentially and each mixture was stirred until uniform to prepare a main agent in advance, and then a curing agent was mixed with the main agents so prepared and the mixtures were stirred until they became uniform and the clear paint compositions of Comparative Examples 1 to 8 were obtained. The results obtained on evaluation are shown in Table 2. Moreover, the paint film performance was evaluated with the procedure indicated hereinafter after preparing test pieces.

TABLE 1

| | | | Example | Example | Example | Example | Example | Example |
|---|---|---|---|---|---|---|---|---|
| | | | 1 | 2 | 3 | 4 | 5 | 6 |
| Main | Hydroxyl group- | A-1 | 70.0 | 70.0 | 70.0 | 70.0 | 70.0 | 70.0 |
| Agent | containing Resin | | | | | | | |
| | (A) Solution | | | | | | | |
| | Hydrolyzable Ester | Ethyl orthoformate | 4.0 | 2.0 | | | 7.5 | 1.5 |
| | Compound (B) | Ethyl orthopropionate | | | 2.0 | 2.0 | | |
| | Alcohol-based | Ethanol | 4.0 | 3.0 | 3.0 | | | 1.5 |
| | solvent (C) | n-Butanol | | | | 3.0 | | |
| | | Isobutanol | | | | | 3.0 | |
| | Other Components | 1) Ultraviolet absorber solution | 2.5 | 2.5 | 2.5 | 2.5 | 2.5 | 2.5 |
| | | 2) Surface controlling agent solution | 2.0 | 2.0 | 2.0 | 2.0 | 2.0 | 2.0 |
| | | Butyl acetate | 7.5 | 10.5 | 10.5 | 10.5 | 5.0 | 12.5 |
| | | 3) Solvesso 100 | 10.0 | 10.0 | 10.0 | 10.0 | 10.0 | 10.0 |

| | | | | | | | |
|---|---|---|---|---|---|---|---|
| Curing Agent | 4) Basonat HI172 | 33.3 | 33.3 | 33.3 | 33.3 | 33.3 | 33.3 |

| Total | | 133.3 | 133.3 | 133.3 | 133.3 | 133.3 | 133.3 |
|---|---|---|---|---|---|---|---|
| Proportion | Solid fraction of hydroxyl | 44.6 | 44.6 | 44.6 | 44.6 | 44.6 | 44.6 |
| of each | group-containing resin (A) | | | | | | |
| component | Hydrolyzable ester compound (B) | 4.0 | 2.0 | 2.0 | 2.0 | 7.5 | 1.5 |
| in the | Alcohol-based solvent (C) | 4.0 | 3.0 | 3.0 | 3.0 | 3.0 | 1.5 |
| paint | (B)/(A) percent (mass %) | 9% | 4% | 4% | 4% | 17% | 3% |
| composition | (C)/(A) percent (mass %) | 9% | 7% | 7% | 7% | 7% | 3% |
| | NCO/OH mol ratio | 0.9 | 0.9 | 0.9 | 0.9 | 0.9 | 0.9 |
| | Involatile fraction of | 51% | 51% | 51% | 51% | 51% | 51% |
| | whole paint composition (mass %) | | | | | | |
| Evaluation | Use-time (1) | ◯ | ◯ | ◯ | ◯ | ◯ | ◯ |
| Results | External appearance of the paint film (2) | ◯ | ◯ | ◯ | ◯ | ◯ | ◯ |
| | Hardness (3) | ◯ | ◯ | ◯ | ◯ | ◯ | ◯ |
| | Acid resistance (4) | ◯ | ◯ | ◯ | ◯ | ◯ | ◯ |

TABLE 2

| | | | Comp. | Comp. | Comp. | Comp. | Comp. | Comp. | Comp. | Comp. |
|---|---|---|---|---|---|---|---|---|---|---|
| | | | Ex. 1 | Ex. 2 | Ex. 3 | Ex. 4 | Ex. 5 | Ex. 6 | Ex. 7 | Ex. 8 |
| Main Agent | Hydroxyl group- | A-1 | 70.0 | 70.0 | 70.0 | 70.0 | 70.0 | 70.0 | 70.0 | 70.0 |
| | containing Resin | | | | | | | | | |
| | (A) Solution | | | | | | | | | |
| | Hydrolyzable Ester | Ethyl orthoformate | 2.0 | 2.0 | 0.5 | 0.5 | 2.0 | 20.0 | 2.0 | 2.0 |
| | Compound (B) | Ethyl orthopropionate | | | | | | | | |
| | Alcohol-based | Ethanol | | 0.5 | 2.0 | 6.0 | 6.0 | 0.5 | 3.0 | 3.0 |
| | solvent (C) | n-Butanol | | | | | | | | |
| | | Isobutanol | | | | | | | | |
| | Other Components | 1) Ultraviolet absorber | 2.5 | 2.5 | 2.5 | 2.5 | 2.5 | 2.5 | 2.5 | 2.5 |
| | | solution | | | | | | | | |
| | | 2) Surface controlling | 2.0 | 2.0 | 2.0 | 2.0 | 2.0 | 2.0 | 2.0 | 2.0 |
| | | agent solution | | | | | | | | |
| | | Butyl acetate | 13.5 | 13.5 | 13.5 | 9.5 | 7.5 | 0.0 | 10.5 | 10.5 |
| | | 3) Solvesso 100 | 10.0 | 10.0 | 10.0 | 10.0 | 10.0 | 5.0 | 10.0 | 10.0 |

| | | | | | | | | | |
|---|---|---|---|---|---|---|---|---|---|
| Curing Agent | 4) Basonat HI172 | 33.3 | 33.3 | 33.3 | 33.3 | 33.3 | 33.3 | 11.1 | 63.0 |

| Total | | 133.3 | 133.8 | 133.8 | 133.8 | 133.3 | 133.3 | 111.1 | 163.0 |
|---|---|---|---|---|---|---|---|---|---|
| Proportion | Solid fraction of hydroxyl | 44.6 | 44.6 | 44.6 | 44.6 | 44.6 | 44.6 | 44.6 | 44.6 |
| of each | group-containing resin (A) | | | | | | | | |
| component | Hydrolyzable ester compound (B) | 2.0 | 2.0 | 0.5 | 0.5 | 2.0 | 20.0 | 2.0 | 2.0 |
| in the | Alcohol-based solvent (C) | 0.0 | 0.5 | 2.0 | 6.0 | 6.0 | 0.5 | 3.0 | 3.0 |
| paint | (B)/(A) percent (mass %) | 4% | 4% | 1% | 1% | 4% | 45% | 4% | 4% |
| composition | (C)/(A) percent (mass %) | 0% | 1% | 4% | 13% | 13% | 1% | 7% | 7% |
| | NCO/OH mol ratio | 0.9 | 0.9 | 0.9 | 0.9 | 0.9 | 0.9 | 0.3 | 1.7 |
| | Involatile fraction of whole | 51% | 51% | 51% | 51% | 51% | 51% | 47% | 55% |
| | paint composition (mass %) | | | | | | | | |
| Evaluation | Use time (1) | X | X | X | X | ◯ | X | ◯ | Δ |
| Results | External appearance of the | ◯ | ◯ | ◯ | ◯ | ◯ | Δ | ◯ | X |
| | paint film (2) | | | | | | | | |
| | Hardness (3) | ◯ | ◯ | ◯ | X | X | ◯ | X | X |
| | Acid resistance (4) | ◯ | ◯ | ◯ | X | X | ◯ | X | ◯ |

The bracketed numbers in Tables 1 and 2 are indicated below.
1) A 20 mass % xylene solution of Tinuvin 900 (ultraviolet absorber, trade name, produced by the Ciba Specialty Chemicals Co.)
2) A 10 mass % xylene solution of BYK-300 (surface controlling agent), trade name, produced by the BYK Chemie Co.)
3) Solvesso 100 (aromatic naphtha, trade name, produced by the Exxon Co.)
4) Basonat HI-172 (HDI based isocyanurate type trimer, trade name, produced by the BASF Co., involatile fraction 72%, NCO content 15.9 mass %, three isocyanate (functional groups) in one molecule)

### Test Piece Production and Evaluation of Paint Film Performance

The cationic electro-deposition paint Aqua No. 4200 (trade name, produced by the BASF Coatings Japan Co.) was electro-deposition coated in such a way as to provide a dry film thickness of 20 μm on a zinc phosphate-treated mild steel sheet and then baked for 25 minutes at 175° C. and then the mid-coat paint HS-H300 (trade name, produced by the BASF Coatings Japan Co.) was air-spray coated in such a way as to provide a dry film thickness of 30 μm and then baked for 30 minutes at 140° C. and a mid-coat paint film was formed. Next Belcoat No. 6000 Black (trade name, produced by the BASF Coatings Japan Co., color: black) which is a solvent-type base-coat paint was air-spray coated on the surface of the mid-coat paint film in such a way as to provide a dry film thickness of pm and, after setting for 3 minutes at 20° C., the abovementioned clear paint compositions of this invention were each air-spray coated wet-on-wet in such a way as to provide a film thickness of 40 μm and then baked for 30 minutes at 140° C. to make test pieces.

The evaluation of paint film external appearance, hardness and acid resistance was carried out using the test pieces obtained in this way.

### Methods of Evaluating Paints and Paint Films

### (1) Use-Time

After mixing the main agent and the curing agent in the preparation of the abovementioned clear paint compositions of Examples 1 to 6 and Comparative Examples 1 to 8 the compositions were left to stand in a constant temperature room set to 20° C. and the times until they were unable to flow were measured as the use-times and an evaluation was carried out on the basis of the following criteria.
◯: More than 24 hours
Δ: From 16 to 24 hours
×: Less than 16 hours

### (2) Paint Film External Appearance

This was evaluated on the basis of the following criteria with a visual observation of the test piece obtained.
◯: When a fluorescent lamp was reflected by the paint film the fluorescent lamp was reflected clearly.
Δ: When a fluorescent lamp was reflected by the paint film there was some blurring of the periphery (profile) of the fluorescent lamp.
×: When a fluorescent lamp was reflected by the paint film there was marked blurring of the periphery (profile) of the fluorescent lamp.

### (3) Hardness

Tests were carried out using an HB pencil (Yuni, trade name, produced by Mitsubishi Pencils) on the basis of JIS K 5600-5-4 Scratch Hardness (Pencil Method) and an evaluation was made on the basis of the following criteria.
◯: On carrying out five tests at different positions damage did not arise two or more times (less than twice)
×: Damage occurred two or more times

### (4) Acid Resistance

A 0.2 ml spot of 0.1N sulfuric acid aqueous solution was placed on a test sheet and heated to 40° C. for 1 hour and then it was rinsed off with water and the extent of any staining mark was observed visually and an evaluation was made on the basis of the following criteria.
◯: No staining mark observed on the paint film
×: Staining mark observed on the paint film

As is clear from the examples and comparative examples, Examples 1 to 6 which were compositions of this invention had better results in terms of use-time and paint film performance than Comparative Examples 1 to 8.

1. A two-liquid type urethane paint composition, comprising:
a main agent comprising a hydroxyl group-containing resin (A), a hydrolyzable ester compound (B) and an alcohol-based solvent (C); and
a curing agent comprising a polyisocyanate compound (D),
the composition being obtained by mixing together the main agent and the curing agent, wherein the (B) component and the (C) component are included in the main agent in amounts from 2 to 35 parts by mass as effective component of the hydrolyzable ester compound (B) and from 2 to 10 parts by mass of the alcohol-based solvent (C) per 100 parts by mass of solid fraction of the hydroxyl group-containing resin (A), and the hydroxyl groups of the hydroxyl group-containing resin (A) and the functional groups of the polyisocyanate compound (D) are mixed in proportions of from 0.5 to 1.5 as the mol ratio of NCO/OH.

2. The two-liquid type urethane paint composition of claim 1, wherein the hydroxyl group-containing resin (A) is an acrylic resin and the polyisocyanate compound (D) is an aliphatic polyisocyanate compound.
